(19) United States
(12) Patent Application Publication
(10) Pub. No.: US 2007/0041285 A1
(43) Pub. Date: Feb. 22, 2007

(54) Optical disk recording and reproducing device capable of high-speed start processing

(75) Inventor: Toshio Iwami, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/505,732

(22) Filed: Aug. 17, 2006

(30) Foreign Application Priority Data
Aug. 18, 2005 (JP) 2005-237145

(51) Int. Cl. G11B 17/22

(52) U.S. Cl. 369/30.32

(57) ABSTRACT

When entering a mode of executing spin-up processing (start), first the storage unit is accessed and when control information related to previous start processing is stored, a parameter adjustment value as control information recorded in the storage unit and management information of the already read optical disk are read to end the spin-up processing.

### BACKGROUND OF THE INVENTION

1. Field of the Invention

The present invention relates to an optical disk recording and reproducing device which records and/or reproduces information in/from an optical disk such as a CD (Compact Disc) or a DVD (Digital Versatile Disc).

2. Description of the Background Art

There conventionally exists an optical disk recording and reproducing device which, by an optical head called an optical pickup, records and/or reproduces information in/from an optical disk in which information recording tracks are formed concentrically or spirally such as a CD or a DVD. Optical pickup, which is designed to converge and irradiate a light beam such as a semiconductor laser onto an optical disk by an objective lens, as well as receiving a reflected light of the light irradiated on the optical disk to output an electric signal according to the received light, moves in the direction of the radius of the optical disk.

An optical disk recording and reproducing device moves an optical pickup to a predetermined position on an optical disk and converges and irradiates a light from the pickup onto recording tracks of the optical disk while rotating the optical disk, thereby recording and/or reproducing information in/from the optical disk.

In reproducing information from the optical disk, focus-on (bringing into focus) is first executed such that a converging point of a light irradiated from the optical pickup locates on the surface of the optical disk and then, track-on (bringing into track) is executed such that the focused on light locates on the recording tracks. These focus-on and track-on are executed by moving an objective lens in a direction perpendicular to the optical disk surface and a direction perpendicular to the recording tracks according to an electric signal output from the optical pickup. Then, in the state of focus-on and track-on, based on the electric signal output from the optical pickup, a pit formed on the optical disk is detected to read information from the optical disk and reproduce the information. Recording of information in the optical disk is executed by forming a pit in the recording tracks of the optical disk by a light converged and irradiated onto the optical disk by the optical pickup.

Also, in the recording and reproduction of the optical disk, based on data of a management region which is recorded in an inner peripheral region of the optical disk, data reading is executed by spin-up processing with respect to discrimination of media and various kinds of parameter values. Then, based on the read data, adjustment is made for executing optical pickup. In this respect, various kinds of systems are proposed for reducing a time after activation, among which Japanese Patent Laying-Open No. 2003-085041 discloses a disk cache system apparently capable of executing start processing quickly by caching data of a disk device by using a nonvolatile memory.

Japanese Patent Laying-Open No. 2003-249021 discloses a system which enables reduction in spin-up processing by adjusting a region to be read based on discrimination of a disk.

On the other hand, when after power application, the power is stopped after the execution of start processing, it is a common practice to again execute the same start processing, for example, spin-up processing, if the state of a device remains unchanged, that is, even if an optical disk is not replaced.

In Japanese Patent Laying-Open No. 2003-085041, although start processing is apparently executed at a high speed by determining whether a hard disk is replaced or not and when not replaced, using data stored in the nonvolatile memory, the start processing itself is executed to require some amount of time.

In this regard, when the device remains in the same state after power application as that of before power application, if information of the start processing used last time can be used, it is unnecessary to execute the start processing, which enables high-speed start processing.

### SUMMARY OF THE INVENTION

The present invention, which aims at solving the above-described problem, is to provide an optical disk recording and reproducing device capable of high-speed start processing when after power application, the state of the device remains the same as that of before the power application.

An optical disk recording and reproducing device according to the present invention includes a control unit for recording and reproducing data by laser irradiation to a recording medium, a storage unit and an insertion and discharge unit for executing insertion or discharge of the recording medium in response to a recording medium insertion instruction or discharge instruction. The control unit reads control information of the recording medium for recording and reproducing data by spin-up processing at the time of insertion of the recording medium after power application, as well as recording the control information in the storage unit to execute recording and reproduction in/from the recording medium based on the control information stored in the storage unit at subsequent power application after the power is stopped, and the control unit erases the control information stored in the storage unit in response to input of the discharge instruction.

The optical disk recording and reproducing device according to the present invention includes a control unit for recording and reproducing data by laser irradiation to a recording medium, and a storage unit. The control unit reads control information of the recording medium for recording and reproducing data by spin-up processing at the time of insertion of the recording medium after power application, as well as storing the control information in the storage unit. The control unit executes recording and reproduction in/from the recording medium based on the control information stored in the storage unit at the time of subsequent power application after the power is stopped.

Preferably, an insertion and discharge unit is further provided for executing insertion or discharge of a recording medium in response to a recording medium insertion instruction or discharge instruction after power application, and the control unit erases the control information stored in storage unit in response to input of the discharge instruction.

The control unit of the optical disk recording and reproducing device according to the present invention is allowed to realize high-speed start processing because after the power is stopped, at the time of subsequent power application, recording and reproduction in/from the recording medium is executed based on the control information stored in the storage unit, which enables recording and reproduction without again executing spin-up processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of an optical disk recording and reproducing device according to an embodiment of the present invention.

FIG. 2 is a flow chart for use in explaining operation executed at the time of insertion and discharge of an optical disk according to the embodiment of the present invention.

FIG. 3 is a flow chart for use in explaining spin-up processing according to the embodiment of the present invention.

### DESCRIPTION OF THE PREFERRED EMBODIMENTS

In the following, an embodiment of the present invention will be described in detail with reference to the drawings. In the figures, the same or corresponding parts will be given the same reference numerals to omit description thereof.

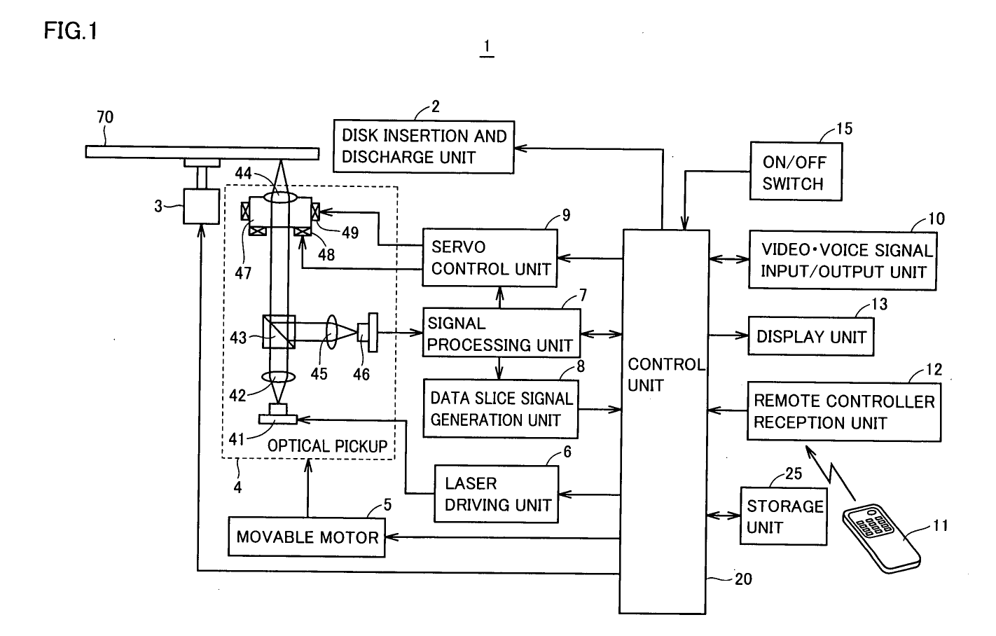

With reference to FIG. 1, an optical disk recording and reproducing device 1 according to the embodiment of the present invention records and/or reproduces information such as music and video in/from an optical disk 70 in which a concentric or spiral information recording track is formed such as a CD or a DVD.

Optical disk recording and reproducing device 1 includes a disk insertion and discharge unit 2, a spindle motor 3, an optical pickup 4, a movable motor 5, a laser driving unit 6, a signal processing unit 7, a data slice signal generation unit 8, and a servo control unit (focusing control unit, tracking control unit) 9. Optical disk recording and reproducing device 1 further includes a video voice signal input/output unit 10, a remote controller 11, a remote controller reception unit 12, a display unit 13, a control unit 20 for controlling the above-described respective units, an ON/OFF switch 15 and a storage unit 25.

Disk insertion and discharge unit 2 carries optical disk 70 inserted through an insertion and discharge inlet not shown in response to an instruction from control unit 20 with the disk mounted on a disk tray, as well as discharging the optical disk mounted on the disk tray in response to an instruction through the insertion and discharge inlet. The inserted optical disk 70 is attached to spindle motor 3. Spindle motor 3 is driven to rotate according to an instruction from control unit 20 so as to control the attached optical disk 70 to rotate at a predetermined speed.

Optical pickup 4, which irradiates a light for recording and/or reproducing information in/from optical disk 70, as well as receiving a reflected light from optical disk 70 to convert the light into an electric signal and output the signal, is moved on optical disk 70 in a direction of its radius by movable motor 5 formed of a linear motor based on an instruction from control unit 20.

Optical pickup 4 converges and irradiates a light emitted from a semiconductor laser 41 onto optical disk 70 through a collimator lens 42, a beam splitter 43 and an objective lens 44. The pickup also receives a reflected light from optical disk 70 by means of an optical detector 46 through objective lens 44, beam splitter 43 and a condenser lens 45.

Semiconductor laser 41 has its light emission controlled by laser driving unit 6 operable in response to an instruction from control unit 20. Optical detector 46, whose light receiving surface is divided into a plurality of regions, is formed of divisional photodiodes which output an electric signal according a light intensity of each part of the light receiving surface, and an output signal from optical detector 46 is input to signal processing unit 7.

Objective lens 44 is held by a lens holder 47 which lens holder 47 is provided with a focusing coil 48 and a tracking coil 49. Focusing coil 48 serves to move objective lens 44 to a direction perpendicular to a disk surface of optical disk 70 by magnetic function with a magnet not shown. Tracking coil 49 similarly serves to move objective lens 44 parallel to the disk surface of optical disk 70 to a direction perpendicular to the recording track of optical disk 70.

Signal processing unit 7 generates an RF signal (reflection intensity) based on an output signal from optical detector 46 and outputs the generated signal to data slice signal generation unit 8. Data slice signal generation unit 8 generates a data slice signal which is obtained by binarizing the RF signal and inputs the generated signal to control unit 20. Control unit 20 detects a pit formed on optical disk 70 based on the data slice signal.

Signal processing unit 7 also generates a focus error signal and a track error signal based on the output signal from optical detector 46 and outputs the generated signals to servo control unit 9. The focus error signal is a signal corresponding to the amount of deviation of a converging point of a light irradiated onto optical disk 70 through objective lens 44 from the optical disk surface and the track error signal is a signal corresponding to the amount of deviation of a converging point from the recording tracks.

Servo control unit 9 controls current supply to focusing coil 48 and tracking coil 49 to move objective lens 44 based on these focus error signal and track error signal, thereby executing servo-control such that the converging point locates on the disk surface of optical disk 70 and on the recording tracks.

Video•voice signal input/output unit 10, to which an external devise such as a display, a speaker, a television receiver or the like not shown is connected, outputs a video signal or a voice signal reproduced from optical disk 70 and receives input of a video signal or a voice signal from the external device.

Remote controller 11, which is for operating various kinds of operation of optical disk recording and reproducing device 1, is provided with operation keys (none is shown) for operating various kinds of operation. Remote controller 11 sends a signal corresponding to operation of these keys as an infrared ray signal. Remote controller reception unit 12 receives the infrared ray signal sent from remote controller 11 and outputs the signal to control unit 20. Display unit 13, which is provided on a front panel of the main body of optical disk recording and reproducing device 1, displays the contents of operation executed by remote controller 11, operation conditions of optical disk recording and reproducing device 1 and the like.

ON/OFF switch 15 is a start switch which supplies power to the entire device in response to on/off of ON/OFF switch 15 to set the device at a state where each of various kinds of operation is enabled. Although the description has been made of a case where the ON/OFF switch is provided on the side of the main body, a switch button having the same function can be provided in remote controller 11, for example. Accordingly, it is assumed in the present invention that turning on of ON/OFF switch 15 brings disk insertion and discharge unit 2 into a state where insertion or discharge of the optical disk is allowed.

Storage unit 25 is assumed to have storage of various kinds of control programs such as a control program for instructing on execution of various kinds of operation and a control program for executing initial operation, and store control information or adjustment data from optical disk 70 which will be described later or the like.

Here, description will be made of recording and reproduction of information in/from optical disk 70. First, in the reproduction of information from optical disk 70, with optical disk 70 rotated at a predetermined speed by spindle motor 3, a light from semiconductor laser 41 is irradiated onto optical disk 70 and the reflected light is received by optical detector 46. Then, servo control unit 9 controls current supply to focusing coil 48 based on the focus error signal from signal processing unit 7 to move objective lens 44, thereby realizing focus-on (brining into focus) such that a converging point of the light from semiconductor laser 41 locates on optical disk 70. Furthermore, servo control unit 9 controls current supply to tracking coil 49 based on the track error signal from signal processing unit 7 to move objective lens 44, thereby realizing track-on (bringing into track) such that a converging point of the light from semiconductor laser 41 locates on a desired recording track.

After focus-on and track-on are established, servo control unit 9 controls current supply to focusing coil 48 and tracking coil 49 based on the focus error signal and the track error signal to execute focusing servo control and tracking servo control so as to maintain the focus-on state and the track-on state.

Then, in the servo state, the RF signal output from signal processing unit 7 is input to data slice signal generation unit 8, so that a data slice signal generated by binarizing the RF signal by data slice signal generation unit 8 is input to control unit 20. Control unit 20 detects existence/non-existence of a pit formed on optical disk 70 based on the data slice signal to read information recorded in optical disk 70, reproduces the read information into a video signal or a voice signal and outputs the reproduced signal to the external device through video•voice signal input/output unit 10.

Recording of information into optical disk 70 is similarly executed by forming, in the focusing and tracking servo state, a pit on optical disk 70 by alight from semiconductor laser 41. At this time, a video signal or a voice signal input from video voice signal input/output unit 10 is coded by control unit 20, so that semiconductor laser 41 has its light emission controlled according to the coded data under the control of control unit 20. As a result, a pit according to the coded data is formed in the recording track of optical disk 70 to record information of video and voice. Formation of a pit is enabled by making semiconductor laser 41 emit at a higher output than that used at the time of reading information.

Thus structured optical disk recording and reproducing device 1 executes reproduction of information from optical disk 70, recording of information into optical disk 70 and the like by operating remote controller 11 under the control of control unit 20. Optical disk recording and reproducing device 1, when optical disk 70 is inserted, executes spin-up processing under the control of control unit 20 to conduct initial operation of reading information recorded on the side of the innermost periphery of optical disk 70. Then, based on the information read by the initial operation, a kind and recording contents of the inserted optical disk 70 are determined. Then, the series of start processing completes operation preparation for executing recording and reproduction or the like of desired information.

In the present embodiment, description will be made of a system of executing high-speed start processing in a predetermined case.

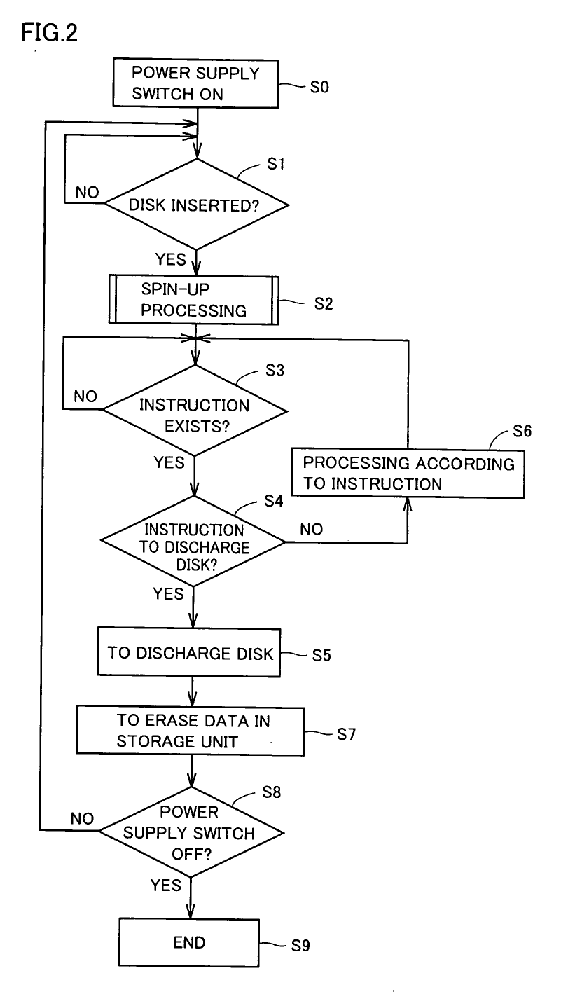

With reference to the flow chart shown in FIG. 2, operation executed at the time of inserting and discharging the optical disk according to the embodiment of the present invention will be described.

With reference to FIG. 2, first a power supply switch is turned on based on ON/OFF switch 15 (Step S0).

Next, the optical disk is inserted through the insertion and discharge inlet (Step S1). When the optical disk is inserted, spin-up processing is executed for executing start processing (Step S2).

Then, after the spin-up processing (Step S2), determination is next made whether a command instruction is made by a remote controller key or the like (Step S3). When an instruction is made, the processing proceeds to the subsequent step and then determination is made whether an instruction to discharge the disk is made as a command instruction or not (Step S4).

When the instruction is not a disk discharge instruction at Step S4, processing according to a predetermined command instruction is executed (Step S6). When a command instruction related to recording or reproduction operation is applied, for example, operation according to the applied instruction is executed. Then, the processing again returns to Step S3.

On the other hand, when the instruction to discharge the disk is made at Step S4, the processing proceeds to Step S5 to discharge the optical disk through the discharge inlet (Step S5).

Then, at the time of discharging the disk, predetermined data stored in storage unit 25 which will be described later is erased (Step S7).

Next, determination is made whether the power supply switch is turned off based on ON/OFF switch 15 (Step S8).

When the power supply switch is turned off, the processing is finished (Step S9). On the other hand, when the power supply switch is not turned off, the processing returns to Step S1 to wait for subsequent insertion of the optical disk.

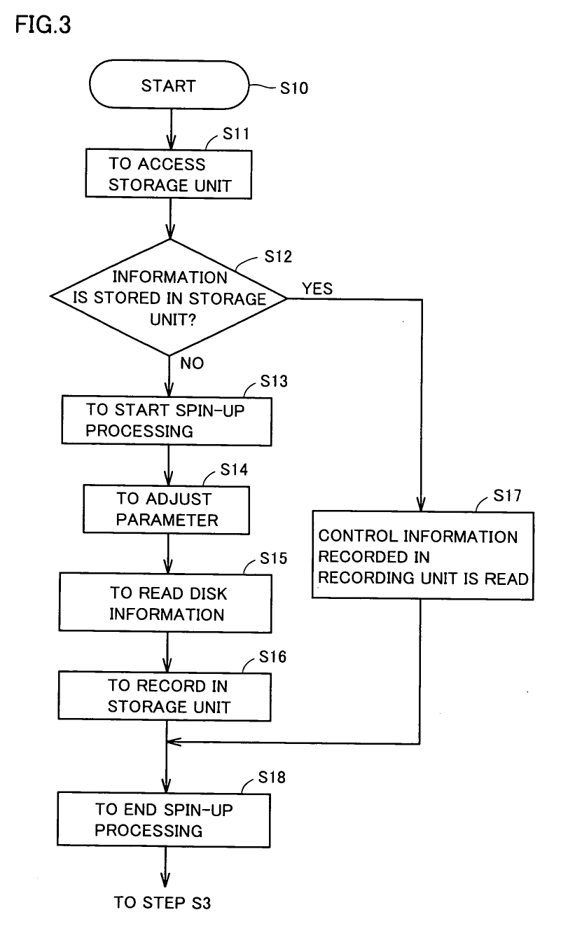

With reference to the flow chart shown in FIG. 3, spin-up processing according to the embodiment of the present invention will be described.

With reference to FIG. 3, when entering a mode of executing the spin-up processing under the control of control unit 20 (start) (Step S10), first, storage unit 25 is accessed (Step S11). Then, determination is made whether control information related to the previous start processing is stored in storage unit 25 (Step S12). The control information related to the previous start processing which is stored in storage unit 25 will be described later.

When the control information related to the previous start processing is not stored in storage unit 25 at Step S12, the processing proceeds to the subsequent step (Step S13).

Then, the above-described spin-up processing is started (Step S13). More specifically, executed are adjustment of laser power for executing reproduction and recording, setting of a parameter adjustment value for adjusting the above-described brining-into-focus or brining-into-track (parameter adjustment) and the like (Step S14). In addition, initial operation is subsequently executed of reading management information recorded on the side of the innermost periphery of optical disk 70 to make determination of a kind and recording contents of optical disk 70 (Step S15). Then, the control information including the parameter read or set based on the series of spin-up processing is recorded in storage unit 25 (Step S16).

Then, the spin-up processing is finished (Step S18). Then, the processing returns to Step S3.

On the other hand, when the control information is stored in storage unit 25 at Step S12, the processing proceeds to Step S17 to read a parameter adjustment value as the control information recorded in storage unit 25 and management information of the already read optical disk and end the spin-up processing (Step S18). Then, the processing proceeds to Step S3.

In the embodiment of the present invention, before starting the spin-up processing after the power is applied, determination is made whether the control information related to the previous start processing is stored in storage unit 25 and when the information is stored, the spin-up processing is finished by using the stored control information.

In other words, when after the power application, the state of the device remains the same as that of before the application, executed is not another spin-up processing but reading the control information obtained by the previous spin-up processing from storage unit 25 and using the information.

Thus, according to the conventional system, in a case where after the power supply is stopped, when the state of the device remains the same after the power application, that is, even when the optical disk is not replaced, the spin-up processing is executed without fail. In other words, the conventional system is a system of executing parameter adjustment and data reading of various kinds of control information while rotating the optical disk.

In the system according to the present invention, when the device remains in the same state after the power application, another execution of the spin-up processing is not required to enable second start processing to be executed at a high speed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical disk recording and reproducing device, comprising:
a control unit for recording and reproducing data by laser irradiation to a recording medium,
a storage unit, and
an insertion and discharge unit for executing insertion or discharge of said recording medium in response to an instruction to insert or an instruction to discharge said recording medium, wherein
said control unit, at the time of insertion of said recording medium after power application, reads control information of said recording medium for recording and reproducing said data by spin-up processing, as well as storing said control information in the storage unit to execute recording and reproduction in/from said recording medium based on said control information stored in said storage unit at the time of subsequent power application after the power is stopped, and
said control unit erases said control information stored in said storage unit in response to input of said discharge instruction.

2. An optical disk recording and reproducing device, comprising:
a control unit for recording and reproducing data by laser irradiation to a recording medium, and
a storage unit, wherein
said control unit, at the time of insertion of said recording medium after power application, reads control information of said recording medium for recording and reproducing said data by spin-up processing, as well as storing said control information in the storage unit, and
said control unit executes recording and reproduction in/from said recording medium based on said control information stored in said storage unit at the time of subsequent power application after the power is stopped.

3. The optical disk recording and reproducing device according to claim 2, further comprising:
an insertion and discharge unit for executing insertion or discharge of said recording medium in response to an instruction to insert or an instruction to discharge said recording medium, wherein
said control unit erases said control information stored in said storage unit in response to input of said discharge instruction.
